(19) United States
(12) Patent Application Publication
(10) Pub. No.: US 2009/0225204 A1
(43) Pub. Date: Sep. 10, 2009

(54) SOLID STATE IMAGING DEVICE AND CAMERA

(76) Inventors: Yuuichi Inaba, Toyama (JP); Takumi Yamaguchi, Kyoto (JP); Yoshiyuki Matsunaga, Kyoto (JP)

Correspondence Address: MCDERMOTT WILL & EMERY LLP, 600 13TH STREET, NW, WASHINGTON, DC, 20005-3096, US

(21) Appl. No.: 12/096,952

(22) PCT Filed: Jun. 27, 2006
(86) PCT No.: PCT/JP2006/312770

§ 371 Date: Jun. 11, 2008

(51) Int. Cl. H04N 5/335

(52) U.S. Cl. 348/273; 348/E05.091

(57) ABSTRACT

A wavelength separation filter 206 is composed of λ/4 multilayer films 302 to 304 that are sequentially laminated on a multilayer interference filter 301. The multilayer interference filter 301 is composed of two λ/4 multilayer films with a dielectric layer sandwiched therebetween. Also, the multilayer interference filter 301 is composed of parts 301B, 301G, 301R that transmit blue light, green light, and red light, respectively. The multilayer interference filter 301 wavelength-separates visible light. The λ/4 multilayer films 302 to 304 reflect light having a wavelength within wavelength ranges having set-wavelengths of 800 nm, 900 nm, and 1000 nm respectively. In other words, the λ/4 multilayer films 302 to 304 reflect near infrared light.

### TECHNICAL FIELD

The present invention relates to a solid-state imaging device and a camera, and particularly to an art for shielding infrared light included in incident light.

### BACKGROUND ART

In recent years, the range of applications for solid-state imaging devices such as digital cameras and mobile phones has been expanding explosively. This increases a demand for solid-state imaging devices capable of imaging using invisible light such as infrared light and ultraviolet light in addition to color-imaging using visible light.

FIG. 1 is a cross-sectional view showing the structure of a solid-state imaging device according to a conventional art (see Patent Document 1, for example). As shown in FIG. 1, a solid-state imaging device 8 is composed of planarizing layers 804 and 805 and an invisible light cut filter 806 that are sequentially laminated on a silicon substrate 801.

The invisible light cut filter 806 is a multilayer film that is composed of alternately laminated dielectric layers and metal layers. Also, photodiodes 802 and CCDs (Charge Coupled Devices) 803 are formed in one surface of a silicon substrate 801 that is closer to the planarizing layer 804.

A red filter 807 for transmitting red light and invisible light is formed inside the planarizing layer 804. Color separation filters 808 are formed inside the planarizing layer 805.

The photodiodes 802 have sensitivity to infrared regions. Accordingly, the cutoff of invisible light by the invisible light cut filter 806 can prevent signal charges from being generated due to infrared light. Therefore, it is possible to perform imaging using visible light with high accuracy.

Incident light that has penetrated through the color separation filter 808 without penetrating through the invisible light cut filter 806 includes only blue light and invisible light. If this incident light further penetrates through the red filter 807, the blue light is cut off. Accordingly, only the invisible light enters the photodiodes 802. This realizes imaging using invisible light.

With the above structure, it is possible to realize a solid-state imaging device capable of imaging using infrared light in addition to color-imaging using visible light.

Patent Document 1: Japanese Patent No. 3078458

Patent Document 2: International Patent Publication No. WO 2005/069376 A1

### DISCLOSURE OF THE INVENTION

### Problems the Invention is Going to Solve

However, a film thickness of the planarizing layer 804 excluding the red filter 807 and a film thickness of the planarizing layer 805 excluding the color separation filters 808 are each substantially 3 μm. Accordingly, a total film thickness of the filters is as much as 6 μm or more.

In such a case, if the pixel size is 2 μm or less, light obliquely entering the color separation filters 808 (hereinafter referred to as “oblique light”) further enters the photodiodes 802 other than the photodiodes 802 respectively corresponding to the color separation filters 808. This causes problems such as deterioration in the color separation function, increase of noises, and deterioration in the wavelength sensitivity.

Furthermore, there is a problem that complicated manufacturing processes lead to high manufacturing cost.

The present invention is made to solve the above-described problems. An object of the present invention is to provide a solid-state imaging device that is capable of shielding infrared light and having a high wavelength separation function and can be manufactured at low cost, and a camera including such a solid-state imaging device.

### Means to Solve the Problems

In order to achieve the above object, the present invention provides a solid-state imaging device that performs color-imaging using visible light, the solid-state imaging device comprising two-dimensionally arrayed pixels each including: a visible light filter that is composed of a multilayer interference filter that mainly transmits visible light having a wavelength within a predetermined wavelength range; and an infrared filter that is composed of a plurality of λ/4 multilayer films each having a different set-wavelength λ and that reflects infrared light, wherein the visible light filter and the infrared filter are layered in contact with each other.

### EFFECT OF THE INVENTION

With this structure, an infrared filter can be structured without metal layers, unlike the conventional art according to the Patent Document 1. Accordingly, it is possible to downsize the solid-state imaging device by reducing a thickness thereof. Also, it is possible to realize a high wavelength separation function by preventing oblique light.

Note that a color filter using a multilayer interference filter has a color separation function in visible regions, as described in the Patent Document 2. However, this color filter cannot shield infrared light of 700 nm to 1000 nm. Therefore, an optical filter for shielding infrared light is required. On the other hand, according to the present invention, a plurality of laminated λ/4 multilayer films can shield infrared light without using an optical filter.

Note that “to mainly transmit visible light having a wavelength within a predetermined wavelength range” means that it is possible to transmit invisible light in addition to visible light having a wavelength within a predetermined wavelength range when a multilayer interference filter is used as a color filter.

The solid-state imaging device according to the present invention is characterized in that the infrared filter is composed of dielectric materials. With this structure, an infrared filter can be formed without planarizing layers, unlike the conventional art according to the Patent Document 1. Accordingly, it is possible to downsize the solid-state imaging device. Also, it is possible to reduce manufacturing cost by reducing the number of steps required in the manufacturing processes of the solid-state imaging device.

The solid-state imaging device according to the present invention is characterized in that the infrared filter is composed of same dielectric materials used as materials of the visible light filter. With this structure, an infrared filter can be formed without metal materials, unlike the conventional art according to the Patent Document 1. Accordingly, it is possible to manufacture the solid-state imaging device using fewer kinds of materials. This can reduce manufacturing cost of the solid-state imaging device.

In this case, the dielectric materials may include titanium dioxide as a higher refractive index material and silicon dioxide as a lower refractive index material. With this structure, it is possible to achieve a high wavelength separation capability by increasing a difference in refractive index between the high refractive index material and the low refractive index material of the λ/4 multilayer films.

The solid-state imaging device according to the present invention is characterized in that the visible light filter is layered on the infrared filter.

With this structure, it is possible to downsize the solid-state imaging device and reduce manufacturing cost of the solid-state imaging device.

Specifically, it is preferable that the multilayer interference filter includes λ/4 multilayer films each having a set-wavelength λ within a visible wavelength range, and the infrared filter is composed of the λ/4 multilayer films each having the set-wavelength λ within an infrared wavelength range. When the set-wavelength of each of the λ/4 multilayer films that constitute the infrared filter is within a range of 700 nm to 1000 nm inclusive, it is possible to realize an excellent wavelength separation capability. In this case, it is preferable that the multilayer interference filter is composed of two λ/4 multilayer films with a dielectric layer sandwiched therebetween.

A camera according to the present invention is a camera having a solid-state imaging device that performs color-imaging using visible light, the solid-state imaging device comprising two-dimensionally arrayed pixels each including: a visible light filter that is composed of a multilayer interference filter that mainly transmits visible light having a wavelength within a predetermined wavelength range; and an infrared filter that is composed of a plurality of λ/4 multilayer films each having a different set-wavelength λ and reflects infrared light, wherein the visible light filter and the infrared filter are layered in contact with each other. With this structure, it is possible to achieve ahigh wavelength separation capability by eliminating an influence of infrared light in performing color-imaging using visible light. Also, it is possible to reduce manufacturing cost of the camera.

### BRIEF DESCRIPTION OF THE DRAWINGS

FIG. 1 is a cross-sectional view showing the structure of a solid-state imaging device according to a conventional art;

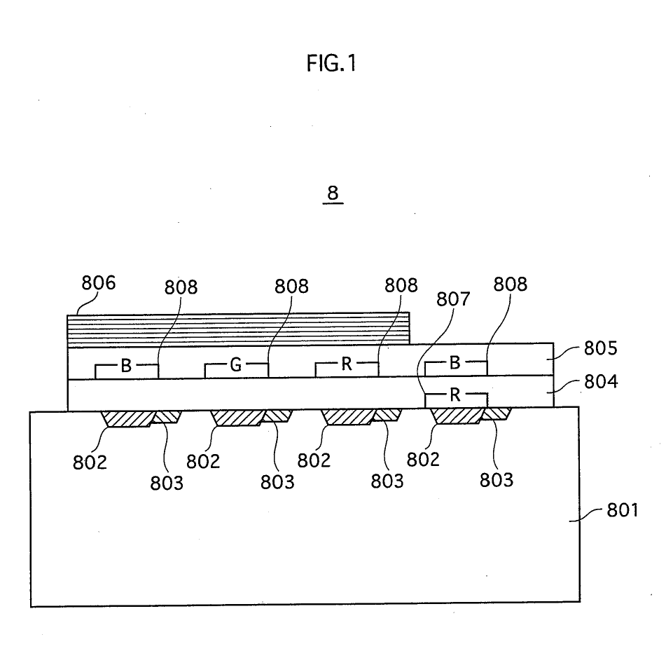

FIG. 2 is a cross-sectional view showing the main structure of a digital camera according to an embodiment of the present invention;

FIG. 3 is a cross-sectional view showing the main structure of a solid-state imaging element 101 according to the embodiment of the present invention;

FIG. 4 is a cross-sectional view showing the structure of a wavelength separation filter 206 according to the embodiment of the present invention;

FIGS. 5A and 5B are graphs showing transmissivity characteristics of the wavelength separation filter 206 according to the embodiment of the present invention, where FIG. 5A shows transmissivity characteristics of the whole of the wavelength separation filter 206, and FIG. 5B shows transmissivity characteristics of a multilayer interference filter 301;

FIG. 6 shows manufacturing processes of the wavelength separation filter 206;

FIGS. 7A to 7C are graphs showing relations between the number of layers of λ/4 multilayer films 302 to 304 and characteristics of wavelength separation, where FIG. 7A shows a relation in a case where x and y are 2 (11 layers in total), FIG. 7B shows a relation in a case where x and y are 4 (19 layers in total), and FIG. 7C shows a relation in a case where x and y are 6 (27 layers in total); and

FIG. 8 is a cross-sectional view showing the structure of a wavelength separation filter according to a modification (3) of the present invention.

### DESCRIPTION OF CHARACTERS

1: digital camera
8: solid-state imaging device according to a conventional art
7 and 206: wavelength separation filter
101: solid-state imaging element
102: imaging lens
103: cover glass
104: gear
105: optical finder
106: zoom motor
107: finder eyepiece
108: LCD monitor
109: circuit board
201: N-type semiconductor layer
202: P-type semiconductor layer
203 and 802: photodiode
204: interlayer insulation film
205: light shielding film
207: condenser lens
301 and 701: multilayer interference filter
302 to 304 and 702 to 704: λ/4 multilayer film
401, 411, 601, 611, and 621: transmissivity characteristic of blue filter
402, 412, 602, 612, and 622: transmissivity characteristic of green filter
403, 413, 603, 613, and 623: transmissivity characteristic of red filter
501, 503, 507, and 509: titanium dioxide layer
502, 504, and 508: silicon dioxide layer
505 and 506: resist
801: silicon substrate
803: CCD
804 and 805: planarizing layer
806: invisible light cut filter
807: red filter
808: color separation filter

### BEST MODE FOR CARRYING OUT THE INVENTION

The following describes an embodiment of a solid-state imaging device and a camera according to the present invention using a digital camera as an example, with reference to the drawings.

[1] Structure of Digital Camera

First, the structure of a digital camera according to the embodiment is described.

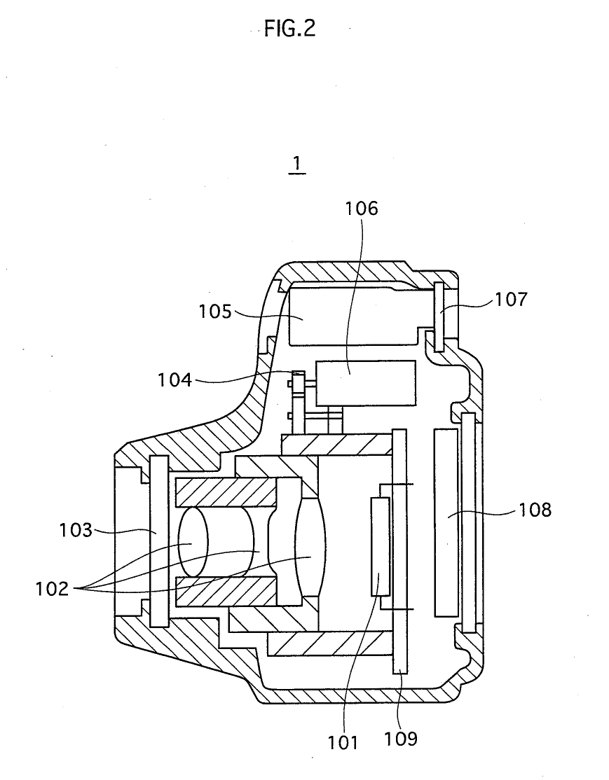

FIG. 2 is a cross-sectional view showing the main structure of the digital camera according to the embodiment.

As shown in FIG. 2, a digital camera 1 includes a solid-state imaging element 101, an imaging lens 102, a cover glass 103, a gear 104, an optical finder 105, a zoom motor 106, a finder eyepiece 107, an LCD (liquid crystal display) monitor 108, and a circuit board 109.

A user of the digital camera 1 observes a subject by looking through the optical finder 105 through the finder eyepiece 107 to select a camera angle. Also, the user operates the zoom motor 106 to adjust a zoom of the imaging lens 102 via the gear 104.

Light from the subject penetrates through the cover glass 103 and the imaging lens 102, and then enters the solid-state imaging element 101. An imaging signal acquired in the solid-state imaging element 101 is signal-processed in the circuit board 109, and is displayed on the LCD monitor 108. Also, on the LCD monitor 108, imaging modes and the like are displayed.

The cover glass 103 protects the imaging lens 102, and furthermore achieves the waterproofing function.

[2] Structure of Solid-State Imaging Element 101

Next, the structure of the solid-state imaging element 101 according to the embodiment is described. The solid-state imaging element 101 includes two-dimensionally arrayed pixels, and performs imaging by detecting an amount of received light for each pixel.

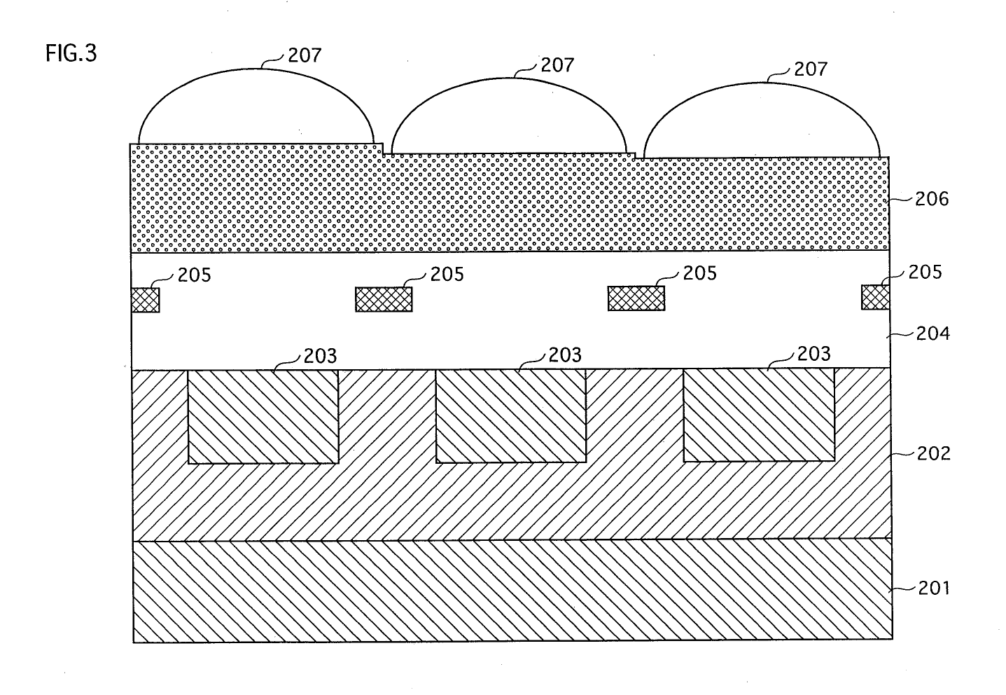

FIG. 3 is a cross-sectional view showing the main structure of the solid-state imaging element 101 according to the embodiment. As shown in FIG. 3, the solid-state imaging element 101 is composed of a P-type semiconductor layer 202, an interlayer insulation film 204, a wavelength separation filter 206, and condenser lenses 207 that are sequentially laminated on an N-type semiconductor layer 201.

A photodiode 203 is formed for each pixel on an inner surface of the P-type semiconductor layer 202 that is closer to the interlayer insulation film 204 by ion-implanting N-type impurities such as arsenic (As). The P-type semiconductor layer 202 that functions as an element separation region separates adjacent photodiodes 203.

Furthermore, the interlayer insulation film 204 is composed of translucent materials such as silicon oxide (SiO₂), silicon nitride (SiN), and borophosphosilicate glass (BPSG). Inside the interlayer insulation film 204, light shielding films 205 are formed, which also function as metal wirings. The light shielding films 205 include apertures respectively corresponding to the photodiodes 203.

The wavelength separation filter 206 realizes color-imaging by transmitting light having a wavelength within a wavelength range predetermined for each pixel. In the embodiment, the wavelength separation filter 206 transmits any of red light, green light, and blue light for each pixel. Furthermore, the wavelength separation filter 206 shields invisible light.

The condenser lens 207 is provided for each pixel, and condenses incident light onto the photodiode 203 corresponding thereto. In this case, the light shielding film 205 shields light such that the incident light condensed by the condenser lens 207 enters only the photodiode 203 corresponding to the condenser lens 207.

[3] Structure of Wavelength Separation Filter 206

Next, the structure of the wavelength separation filter 206 is described in further detail.

The wavelength separation filter 206 is composed of an infrared filter for shielding infrared light that is laminated on a visible light filter for transmitting any of red light, green light, and blue light. The visible light filter is composed of a multilayer interference filter. The infrared filter is composed of a plurality of λ/4 multilayer films.

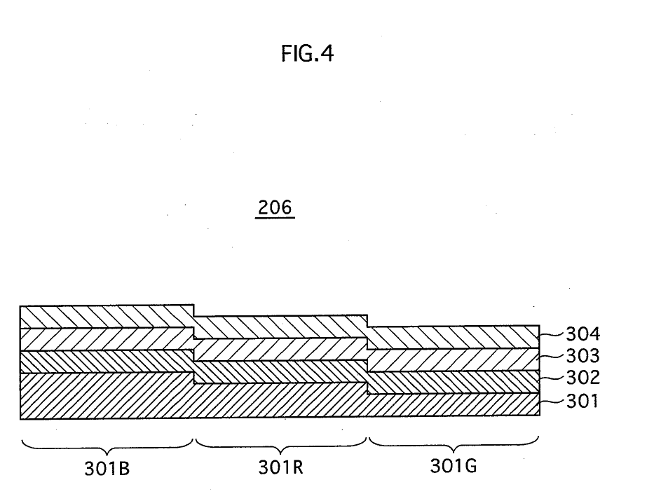

FIG. 4 is a cross-sectional view showing the structure of the wavelength separation filter 206. As shown in FIG. 4, the wavelength separation filter 206 is composed of λ/4 multilayer films 302 to 304 that are sequentially laminated on a multilayer interference filter 301. Although the condenser lenses 207 are provided on the wavelength separation filter 206 and the interlayer insulation film 204 is provided beneath the wavelength separation filter 206 as shown in FIG. 3, these compositional elements are omitted in FIG. 4. The multilayer interference filter 301 is composed of a part for transmitting blue light (“blue filter”) 301B, a part for transmitting green light (“green filter”) 301G, and a part for transmitting red light (“red filter”) 301.

The multilayer interference filter 301 is composed of two λ/4 multilayer films with a dielectric layer (“spacer layer”) sandwiched therebetween. Each of the λ/4 multilayer films is a multilayer film composed of two types of dielectric layers that are alternately laminated and have the same optical thickness and different refractive indexes. The λ/4 multilayer film reflects light having a wavelength within a wavelength range that has, as a center wavelength, four times an optical thickness of the dielectric layer (hereinafter referred to as a “set-wavelength”). Here, the optical thickness is a value obtained by multiplying a physical thickness of the dielectric layer by a refractive index of the dielectric layer. A λ/4 multilayer film having a set-wavelength of 530 nm has an optical thickness of 132.5 nm for each dielectric layer.

In the embodiment, titanium dioxide (TiO₂) is used as a material of a high refractive index layer, and silicon dioxide (SiO₂) is used as a material of a low refractive index layer. Since titanium dioxide has a refractive index of 2.51, the high refractive index layer has a physical thickness of 52.8 nm. Since silicon dioxide has a refractive index of 1.45, the low refractive index layer has a physical thickness of 91.4 nm.

The spacer layer is a translucent insulation layer composed of silicon dioxide, and has a film thickness corresponding to a wavelength of light to be transmitted by the wavelength separation filter 206. The spacer layer has physical thicknesses of 130 nm, 0 nm, and 30 nm in the blue filter 301B, the green filter 301G, and the red filter 301R, respectively.

In the multilayer interference filter 301, the blue filter 301B and the red filter 301R are each composed of seven layers, and the green filter 301G is composed of five layers.

The λ/4 multilayer films 302 to 304 have set-wavelengths different from each other that are in a range of 800 nm to 1000 nm. In the embodiment, the λ/4 multilayer films 302 to 304 have set-wavelengths of 800 nm, 900 nm, and 1000 nm, respectively. Each of the λ/4 multilayer films 302 to 304 has a constant film thickness regardless of color of light transmitted by the multilayer interference filter 301.

Each of the λ/4 multilayer films 302 to 304 is composed of alternately laminated silicon dioxide layers and titanium dioxide layers in the same way as the multilayer interference filter 301. The layer structure of the λ/4 multilayer films 302 to 304 is expressed as below.

(0.5L₁·H₁·0.5L₁)^{x}(0.5L₂·H₂·0.5L₂)(0.5L₃˜H₃·0.5L₃)^{y}

L₁, L₂, and L₃ represent low refractive index layers of the λ/4 multilayer films 302 to 304, respectively. H₁, H₂, and H₃ represent high refractive index layers of the λ/4 multilayer films 302 to 304, respectively. 0.5Lᵢ (i=1 to 3) represents a low refractive index layer having an optical thickness equal to ½ of Li.

(0.5Lᵢ·Hᵢ·0.5Lᵢ) represents a laminated structure in which a high refractive index layer Hᵢ having an optical thickness equal to ¼ of the set-wavelength and a low refractive index layer 0.5Lᵢ having an optical thickness equal to ⅛ of the set-wavelength are sequentially laminated on a low refractive index layer 0.5Lᵢ having an optical thickness equal to ⅛ of the set-wavelength.

Also, (0.5Lᵢ·Hᵢ·0.5Lᵢ)ⁿ represents a laminated structure in which the laminated structure (0.5Lᵢ·Hᵢ·0.5Lᵢ) is repeated n times. Note when the laminated structure (0.5Lᵢ·Hᵢ·0.5Lᵢ) is repeated a plurality of times, the highest layer 0.5Lᵢ included in the lower laminated structure (0.5Lᵢ·Hᵢ·0.5Lᵢ) and the lowest layer 0.5Lᵢ included in the higher laminated structure (0.5Lᵢ·Hᵢ·0.5Lᵢ) constitute a low refractive index layer Lᵢ having an optical thickness equal to ¼ of the set-wavelength.

Likewise, the highest layer 0.5L₁ included in the λ/4 multilayer film 302 and the lowest layer 0.5L₂ included in the λ/4 multilayer film 303 constitute a single silicon dioxide layer. The highest layer 0.5L₂ included in the λ/4 multilayer film 303 and the lowest layer 0.5L₃ included in the λ/4 multilayer film 304 constitute a single silicon dioxide layer. Also, x and y are 11. Accordingly, in the embodiment, the total number of layers that constitute the λ/4 multilayer films 302 to 304 is 23.

[4] Transmissivity Characteristics

Next, transmissivity characteristics of the wavelength separation filter 206 are described.

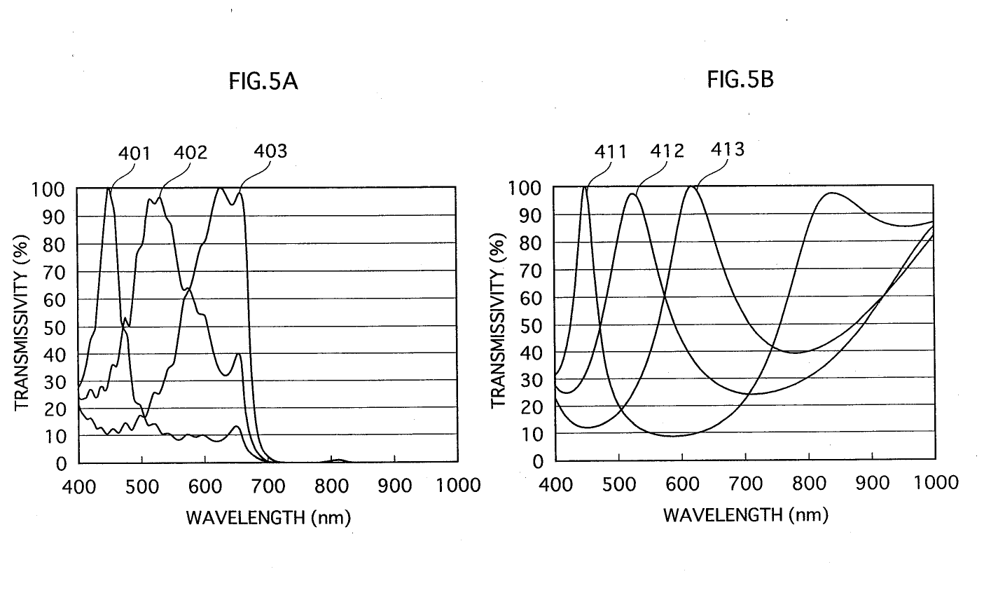

FIGS. 5A and 5B are graphs showing transmissivity characteristics of the wavelength separation filter 206 according to the embodiment, where FIG. 5A shows transmissivity characteristics of the whole of the wavelength separation filter 206, and FIG. 5B shows transmissivity characteristics of the multilayer interference filter 301.

In FIG. 5, graphs 401 and 411 show transmissivity characteristics relating to the blue filter 301B. Also, graphs 402 and 412 show transmissivity characteristics relating to the green filter 301G. Graphs 403 and 413 show transmissivity characteristics relating to the red filter 301.

As shown in FIG. 5A, with the use of the wavelength separation filter 206 according to the embodiment, wavelength separation of incident light can be performed for each of the three wavelength ranges in visible light region. Furthermore, transmissivity of light having a wavelength within a wavelength range of 700 nm to 1000 nm can be suppressed to 2% or less, with respect to all of the red filter 301, the green filter 301G, and the blue filter 301B.

On the other hand, as shown in FIG. 5B, with the use of only the multilayer interference filter 301, wavelength separation of incident light can be performed for each of the three wavelength ranges in visible light region. However, the transmissivity of light having a wavelength within the wavelength range of 700 nm to 1000 nm increases. For example, the blue filter 301B has a as much as 80% or more transmissivity of infrared light having a wavelength within a wavelength range of 800 nm or more.

If receiving such infrared light, the photodiodes 203 generate signal charges. Accordingly, the use of only the multilayer interference filter 301 for color-imaging using visible light cannot achieve a sufficient wavelength separation function.

On the other hand, with the use of the wavelength separation filter 206 according to the embodiment, infrared light does not enter the photodiodes 203. Therefore, it is possible to achieve a high wavelength separation function.

[5] Manufacturing Method of Wavelength Separation filter 206

Next, a manufacturing method of the wavelength separation filter 206 is described.

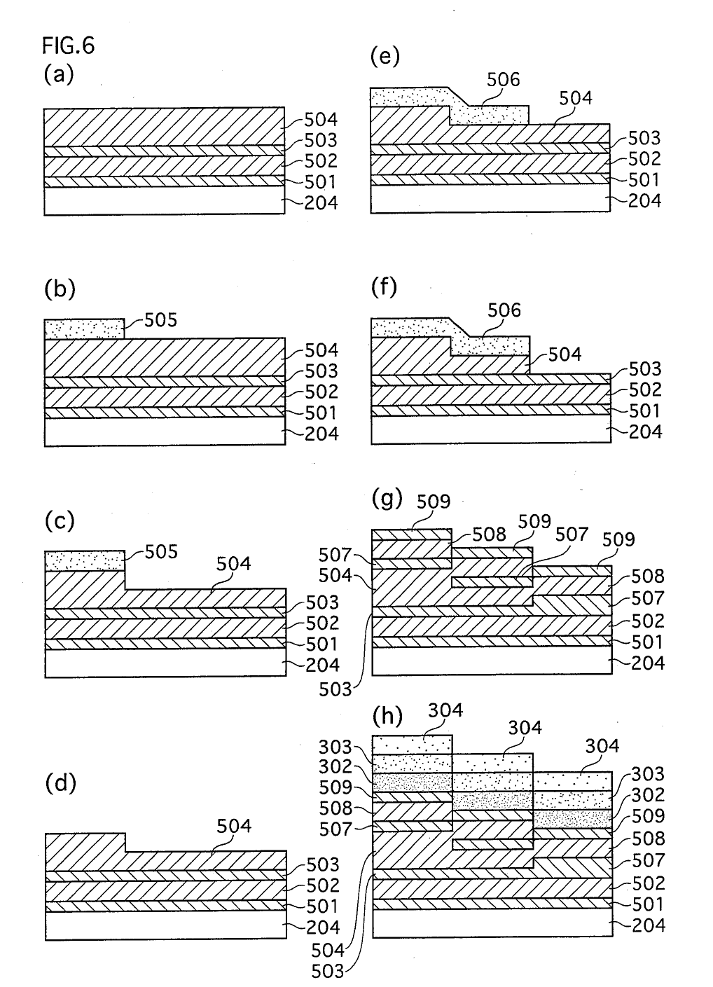

FIG. 6 shows manufacturing processes of the wavelength separation filter 206 according to the embodiment. In FIG. 6, the manufacturing processes of the wavelength separation filter 206 proceed from a process (a) to a process (h). Also, depictions of the N-type semiconductor layer 201, the P-type semiconductor layer 202, the photodiodes 203, and the light shielding films 205 are omitted in FIG. 6.

First, as shown in the process (a), a titanium dioxide layer 501, a silicon dioxide layer 502, a titanium dioxide layer 503, and a silicon dioxide layer 504 are sequentially laminated on the interlayer insulation film 204 using an RF (radio frequency) sputtering device.

The titanium dioxide layers 501 and 503 and the silicon dioxide layer 502 each have an optical thickness of 132.5 nm, and these layers constitute a λ/4 multilayer film. Also, the silicon dioxide layer 504 has a physical thickness equal to a physical thickness of a spacer layer that constitutes the blue filter 301B.

Next, a resist 505 is formed on a part of the silicon dioxide layer 504 that corresponds to the blue filter 301B (a process (b)). A part of the silicon dioxide layer 504 on which the resist 505 is not formed is etched to reduce a film thickness thereof (a process (c)). Then, the resist 505 is removed (a process (d)).

Furthermore, a resist 506 is formed on a part of the silicon dioxide layer 504 that correspond to the red filter 301R and the blue filter 301B (a process (e)). After a part of the silicon dioxide layer 504 on which the resist 506 is not formed is etched (a process (f)), the resist 506 is removed.

In order to etch the silicon dioxide layer 504, for example, a resist material is applied on a wafer surface, pre-exposure baking (prebake) is performed. Then, exposure is performed using a lithography device such as a stepper, and the resists 505 and 506 are formed by performing resist development and final baking (postbake). Then, the silicon dioxide layer 504 can be physically etched using a tetrafluoromethane (CF₄) etching gas.

Next, on the silicon dioxide layer 504 and on a part of the titanium dioxide layer 503 that corresponds to the green filter 301G, titanium dioxide layers 507, silicon dioxide layers 508, and titanium dioxide layers 509 are sequentially formed using an RF sputtering device (a process (g)). As a result, the blue filter 301B and the red filter 301R are each composed of seven layers. The green filter 301G is composed of five layers including, as one layer, a titanium dioxide layer composed of the titanium dioxide layer 507 laminated on the titanium dioxide layer 503.

Then, silicon dioxide layers and titanium dioxide layers are alternately laminated on the titanium dioxide layer 509 to form the λ/4 multilayer films 302 to 304 (the process (h)). As described above, the λ/4 multilayer films 302 to 304 have set-wavelengths of 800 nm, 900 nm, and 1000 nm, respectively.

[6] Modifications

Although the present invention has been described based on the above embodiment, the present invention is not of course limited to the embodiment, and further includes the following modifications.

(1) Although only the case in which the total number of layers that constitute the λ/4 multilayer films 302 to 304 is 23 has been described in the above embodiment, the present invention is of course not limited to this structure. Instead, a λ/4 multilayer film composed of any other number of layers may be used.

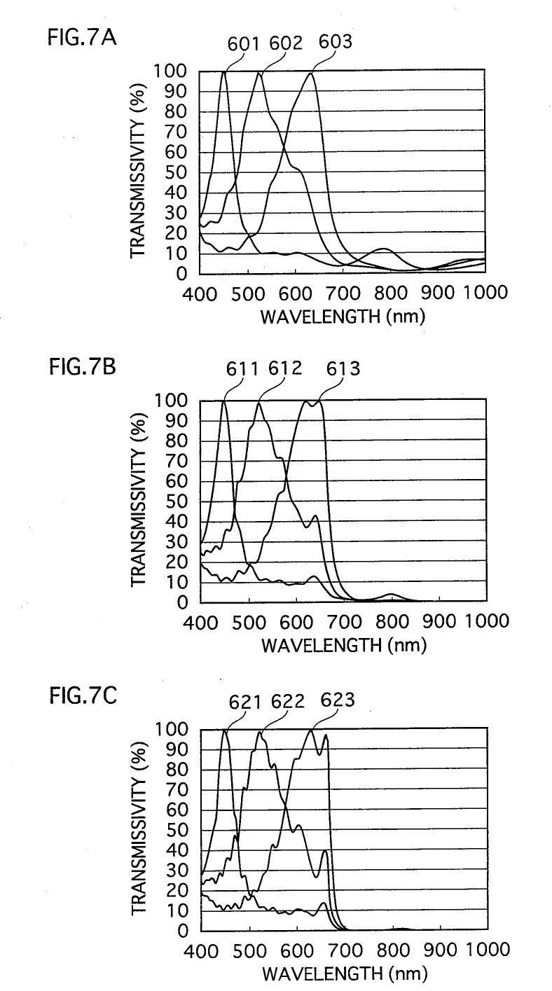

FIGS. 7A to 7C are graphs showing relations between the total number of layers of the λ/4 multilayer films 302 to 304 and characteristics of wavelength separation, where FIG. 7A shows a relation in a case where x and y are 2 (11 layers in total), FIG. 7B shows a relation in a case where x and y are 4 (19 layers in total), and FIG. 7C shows a relation in a case where x and y are 6 (27 layers in total).

Note that each of the λ/4 multilayer films 302 to 304 has a set-wavelength that is the same as that in the above embodiment. Also, in FIG. 7, graphs 601, 611, and 621 show transmissivity characteristics of the blue filter 301B. Furthermore, graphs 602, 612, and 622 show transmissivity characteristics of the green filter 301G. Graphs 603, 613, and 623 show transmissivity characteristics of the red filter 301R.

As shown in FIGS. 7A to 7C, the transmissivity of light having a wavelength within a wavelength range of 700 nm to 1000 nm exceeds 10% in FIG. 7A, drops to 5% or less in FIG. 7B, and is suppressed to 1% or less in FIG. 7C. In this way, as the λ/4 multilayer films 302 to 304 have more number of layers, the transmissivity of light having a wavelength within the wavelength range of 700 nm to 1000 nm is reduced more. Accordingly, better transmissivity characteristics can be achieved.

However, increase in the number of layers might cause increase in manufacturing cost and decrease in yield rate. Therefore, it is desirable that the number of layers is determined so as to achieve characteristics of wavelength separation commensurate with manufacturing cost.

(2) Although only the case in which three kinds of λ/4 multilayer films each having a different set-wavelength is used for shielding infrared light is described in the above embodiment, the present invention is of course not limited to this structure. Instead of the three kinds of λ/4 multilayer films, two kinds of λ/4 multilayer films or four kinds of λ/4 multilayer films may be used. Furthermore, a λ/4 multilayer film having a set-wavelength different from that in the above embodiment may be used for shielding infrared light.

However, needles to say, a set-wavelength of a λ/4 multilayer film needs to be determined so as to shield infrared light, at least near infrared light having a wavelength within a wavelength range of 700 nm to 1000 nm.

(3) Although only the case in which the λ/4 multilayer films are formed on the multilayer interference film 301 is described in the above embodiment, the present invention is of course not limited to this structure. Instead, a multilayer interference film may be formed on a λ/4 multilayer film.

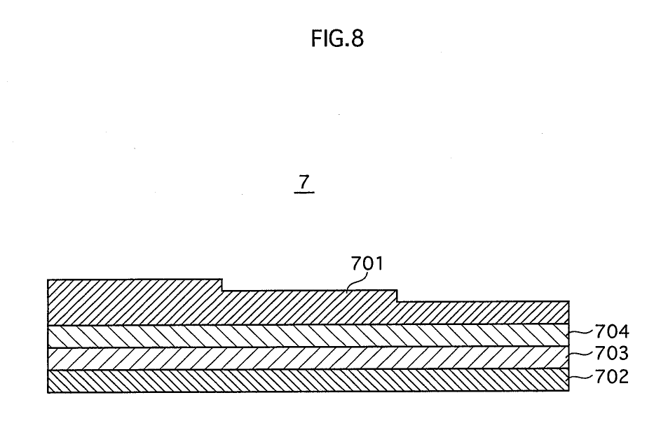

FIG. 8 is a cross-sectional view showing the structure of a wavelength separation filter according to the modification (3). As shown in FIG. 8, a wavelength separation filter 7 according to the modification (3) is composed of λ/4 multilayer films 703 and 704 and a multilayer interference film 701 that are sequentially laminated on a λ/4 multilayer film 702.

With this structure, no difference is formed between pixels in the λ/4 multilayer films 702 to 704. In other words, dielectric layers that constitute the λ/4 multilayer films 702 to 704 can be planarized over a plurality of two-dimensionally arrayed pixels. This can suppress deterioration in characteristics caused by oblique light, which becomes prominent due to pixel size reduction.

(4) Although only the case in which silicon dioxide and titanium dioxide are used as the dielectric materials is described in the above embodiment, the present invention is of course not limited to this structure. Instead, the following may be used: magnesium oxide (MgO), ditantalum pentoxide (Ta₂O₅), zirconium dioxide (ZrO₂) silicon nitride (SiN), trisilicon tetranitride (Si₃N₄), dialuminum trioxide (Al₂O₃), magnesium difluoride (MgF₂), and hafnium trioxide (HfO₃).

Particularly, trisilicon tetranitride, ditantalum pentoxide, and zirconium dioxide are preferably used as high refractive index materials. Regardless of type of dielectric materials, the effects of the present invention can be achieved.

(5) Although the case in which each of the λ/4 multilayer films that constitute the multilayer interference film as a visible light filter is composed of eight layers is described in the above embodiment, the present invention is of course not limited to this structure. Instead, the λ/4 multilayer interference films may be composed of four layers, 12 layers, 16 layers, or more number of layers.

Also, the spacer layer may be composed of a material that is the same as a material of the high refractive index layer of the λ/4 multilayer films or a material of the low refractive index layer of the λ/4 multilayer films. Furthermore, the spacer layer may be composed of a material that is different from all the materials of the layers that constitute the λ/4 multilayer films.

### INDUSTRIAL APPLICABILITY

The solid-state imaging device and the camera according to the present invention are effective as an art for shielding infrared light included in incident light.

1. A solid-state imaging device that performs color-imaging using visible light, the solid-state imaging device comprising
two-dimensionally arrayed pixels each including:
a visible light filter that is composed of a multilayer interference filter that mainly transmits visible light having a wavelength within a predetermined wavelength range; and
an infrared filter that is composed of a plurality of λ/4 multilayer films each having a different set-wavelength λ and that reflects infrared light, wherein the visible light filter and the infrared filter are layered in contact with each other.

2. The solid-state imaging device of claim 1, wherein
the infrared filter is composed of dielectric materials.

3. The solid-state imaging device of claim 1, wherein
the infrared filter is composed of same dielectric materials used as materials of the visible light filter.

4. The solid-state imaging device of claim 3, wherein
the dielectric materials include titanium dioxide as a higher refractive index material and silicon dioxide as a lower refractive index material.

5. The solid-state imaging device of claim 1, wherein
the visible light filter is layered on the infrared filter.

6. The solid-state imaging device of claim 1, wherein
the multilayer interference filter includes λ/4 multilayer films each having a set-wavelength λ within a visible wavelength range, and
the infrared filter is composed of the λ/4 multilayer films each having the set-wavelength λ within an infrared wavelength range.

7. The solid-state imaging device of claim 6, wherein
the set-wavelength of each of the λ/4 multilayer films that constitute the infrared filter is within a range of 700 nm to 1000 nm inclusive.

8. The solid-state imaging device of claim 1, wherein
the multilayer interference filter is composed of two λ/4 multilayer films with a dielectric layer sandwiched therebetween.

9. A camera having a solid-state imaging device that performs color-imaging using visible light, the solid-state imaging device comprising
two-dimensionally arrayed pixels each including:
a visible light filter that is composed of a multilayer interference filter that mainly transmits visible light having a wavelength within a predetermined wavelength range; and
an infrared filter that is composed of a plurality of λ/4 multilayer films each having a different set-wavelength λ and reflects infrared light, wherein
the visible light filter and the infrared filter are layered in contact with each other.
